(19) United States
(12) Patent Application Publication
(10) Pub. No.: US 2002/0090010 A1
(43) Pub. Date: Jul. 11, 2002

(54) Method for the transmission of telecommunications signals

(75) Inventor: Rainer Bader, Leinfelden (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/023,806

(22) Filed: Dec. 21, 2001

(30) Foreign Application Priority Data
Jan. 9, 2001 (DE) 101 00 584.9

(51) Int. Cl. H04J 3/12

(52) U.S. Cl. 370/524; 370/522

(57) ABSTRACT

The object of the invention is to provide a cost-effective alternative for the extending of the degree of local freedom in the use of in-house terminal devices. In the method according to the invention, for the purpose of transmitting telecommunications signals, telecommunications signals received from the telecommunications network (1) of the network operator are forwarded via the local, in-house power supply network (5) of the end customer. The local, in-house power supply network (5) of the end customer includes a facility (7) for generating a connection between the telecommunications network (1) of the network operator and the in-house power supply network (5) of the end customer for the purpose of rendering possible the transmission of telecommunications signals via the in-house power supply network (5) of the end customer.

The invention is based on a priority application DE 101 00 584.9 which is hereby incorporated by reference. The invention concerns a method for the transmission of telecommunications signals.

### BACKGROUND OF THE INVENTION

Telecommunications signals are normally transmitted to an end customer via a telecommunications network. In-house, the telecommunications signals are forwarded via an in-house telecommunications network. The network termination forms the interface between the in-house telecommunications network and that of the network operator.

Due to the normally very limited number of in-house TAE sockets, the scope of in-house application of terminal devices is locally restricted. DECT already offers an alternative for voice services such as telephony, to extend the degree of local freedom. In the case of Internet surfing, there is still a need for a TAE socket close to a PC, or for the use of long, surface-laid cables, which is unsightly. Bluetooth is intended to remedy this, but will still necessitate relatively expensive additional equipment or even entirely new equipment. Moreover, customers could be deterred from purchase by the radio-signal radiation and the resultant in-house electronic smog.

In addition, new network operators, for example, powerline network operators, are crowding into the telecommunications market. Powerline network operators are seeking to expand their already existing power supply networks by additionally offering telecommunications services through them, thereby creating so-called powerline networks. The telecommunications signals are transmitted via the power supply network of the power network operator and the in-house power supply network of the end customer. Both 110 or 220 volt signals and telecommunications signals are then tapped from the mains sockets of the in-house power supply network via adapters, and telecommunications signals are fed into them. Since a house has many distributed mains sockets, the degree of local freedom is extended. However, the implementation of powerline networks requires a large amount of investment. Costs are incurred due, for example, to interference problems between telecommunications and power signals and at transformer stations past which the telecommunications signals have to be routed.

### SUMMARY OF THE INVENTION

The object of the invention is to provide a cost-effective alternative for the extending of the degree of local freedom in the use of in-house terminal equipment.

The object is achieved by a facility for an end customer for generating a connection between a telecommunications network of a network operator and an in-house power supply network of the end customer for rendering possible the transmission of telecommunications signals (POTS; ISDN; DSL) via the in-house power supply network of the end customer, a local, in-house power supply network of an end customer, comprising a facility for generating a connection between a telecommunications network of a network operator and the in-house power supply network of the end customer, for rendering possible the transmission of telecommunications signals (POTS; ISDN; DSL) via the in-house power supply network of the end customer and a method for the transmission of telecommunications signals, in which telecommunications signals (POTS; ISDN; DSL) received from a telecommunications network of a network operator are forwarded via a local, in-house power supply network of an end customer.

In the case of the invention, a connection is created between a telecommunications network of a network operator and an in-house power supply network of an end customer. By simple means, the customer obtains the possibility of connecting telecommunications terminal devices to mains sockets without the need to change the telecommunications network operator. The in-house power supply network already exists, so that investment is limited to a bridge between the external telecommunications network and the in-house power supply network, and an adapter for each connected terminal device. In the case of new buildings, there is no need for the laying of in-house telecommunications cables. In the case of the method according to the invention for the transmission of telecommunications signals, telecommunications signals received from the telecommunications network of the network operator are forwarded via the local, in-house power supply network of the end customer. The local, in-house power supply network of the end customer includes a facility for generating a connection between the telecommunications network of the network operator and the in-house power supply network of the end customer for the purpose of rendering possible the transmission of telecommunications signals via the in-house power supply network of the end customer. The in-house power supply network of the end customer can be laid within an apartment, a single-family house, a commercial premises or distributed to several houses, e.g. a company with several company buildings. What is important is common telecommunications charging and common power charging. In respect of connection, it must be ensured, firstly, that no power signals enter the external telecommunications network and, secondly, that no telecommunications signals enter the external power supply network. The telecommunications signals are transmitted in the in-house network superposed on the power signals. The connection is realized by simple means, for example, with the use of two filters. The first filter is connected between an external telecommunications network and an internal power supply network. It forwards telecommunications signals and blocks power signals. Power signals are generally transmitted at 50 Hz. If the first filter is not transmissive of 50 Hz, it blocks the power signals, which cannot then enter the external telecommunications network. The second filter is connected between an external power supply network and an internal power supply network. The second filter forwards power signals and blocks telecommunications signals. The second filter is transmissive only in the region of, for example, around 50 Hz. Telecommunications signals, which are not normally transmitted in this frequency range, are thus blocked. If direct-current signals are transmitted via the external telecommunications network for the purpose of remote power feeding, they must not enter the internal power supply network. The direct-current signals would create a d.c. offset which would result in numerous terminal devices such as, for example, pressing irons, being destroyed when operated. In this case, the first filter is designed so that it does not forward any direct-current signals. In addition to the prevention of hazards, the measure whereby the direct-current signals received from the telecommunications network of the network operator are not forwarded via the local, in-house power supply network of the end customer has the major advantage, for the operator of the telecommunications network, that power is fed to terminal devices connected to the internal power supply network via the external power supply network of the power network operator, and not via the remote power feed of the telecommunications network. Consequently, the operator of the telecommunications network has no expenditure for the provision of remote power feeds, which represents a substantial cost saving. At the same time, the power consumption of the terminal devices is charged through the power meters of the end customer, as a result of which the power network operator obtains an additional source of revenue. For the individual end customers, the additional power costs are only a very small additional charge, whereas this provides the operator of the telecommunications network, with thousands of end customers, with a very substantial cost saving, and provides the power network operator, likewise with thousands of end customers, with a substantially increased turnover.

Advantageous developments of the invention are disclosed by the dependent claims and the following description.

### BRIEF DESCRIPTION OF THE DRAWINGS

Embodiment examples of the invention are explained in the following with reference to figures, wherein:

FIG. 1 shows a schematic representation of a connection, according to the invention, to an in-house power supply network,

FIG. 2 shows a frequency diagram,

FIG. 3 shows a detailed representation of the connection, according to the invention, to the in-house power supply network,

FIG. 4 shows a structure of a connection according to the invention,

FIG. 5 shows a structure of an adapter and of a terminal device,

FIG. 6 shows a structure of a further adapter and of a further terminal device,

FIG. 7 shows a structure of a further terminal device,

FIG. 8 shows a schematic representation of a further connection to the in-house power supply network,

FIG. 9 shows a schematic representation of a further connection to the in-house power supply network,

FIG. 10 shows a structure of a fuse box, and

FIG. 11 shows a structure of a telecommunications exchange.

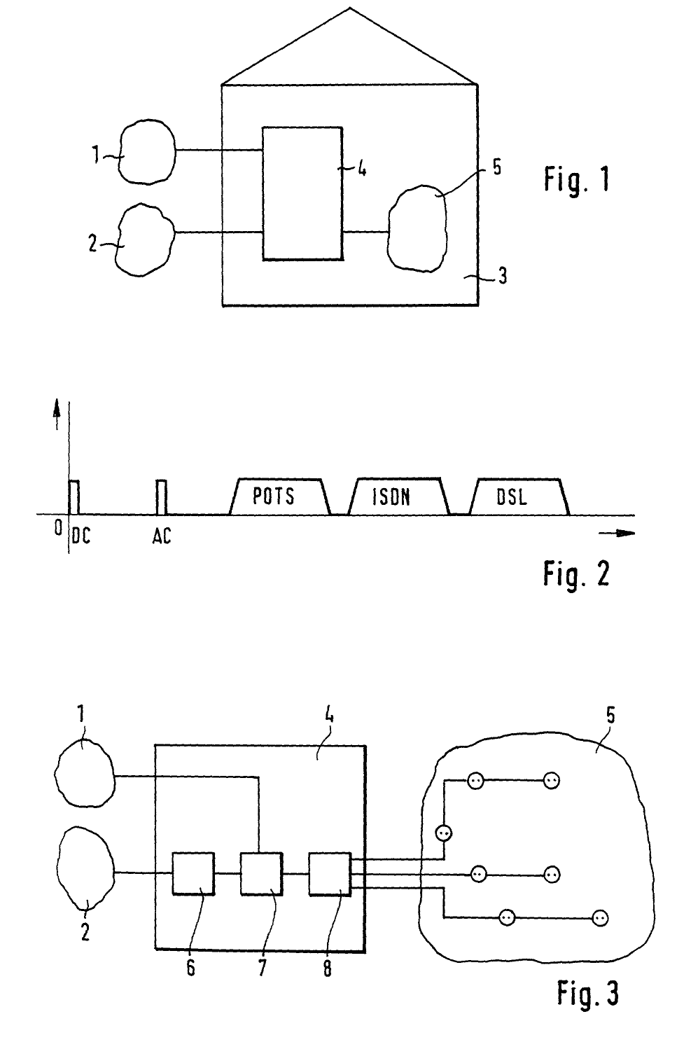

The first embodiment example is now explained with reference to FIGS. 1 to 8. FIG. 1 shows a schematic representation of a connection, according to the invention, to an in-house electrical power supply network. A telecommunications network 1 transmits telecommunications signals to an end customer. A power supply network 2 of a power network operator transmits power to the end customer. The telecommunications signals and the electrical power are received in the house 3 of the end customer. An in-house power supply network 5 is provided, which serves primarily to distribute the received electrical power. The in-house power supply network 5 supplies power to electrical devices of the end customer. These devices are, for example, domestic appliances such as a refrigerator, dishwasher, washing machine, vacuum cleaner, or television set, hifi system or radio alarm clock. In addition, the in-house power supply network 5 is used for the transmission of telecommunications signals. A connection between the three networks is provided by the facility 4. The facility 4 serves both to forward the power signals from the power supply network 2 into the in-house power supply network 5 and to create a bidirectional connection between the telecommunications network 1 and the in-house power supply network 5, for the purpose of forwarding received telecommunications signals via the in-house power supply network 5 or the telecommunications network 1. The telecommunications signals are forwarded transparently, i.e., there is no protocol conversion or adaptation. Costs are thus minimized. The facility 4 additionally prevents direct-current signals transmitted in the telecommunications network 1 as a remote power feed from entering either the power supply network 2 or the in-house power supply network 5. Furthermore, the facility 4 prevents telecommunications signals from entering the power supply network 2. In this way, there are two independent networks outside the house, one for telecommunications signals and one for power signals and, within the house, one network via which both telecommunications signals and electrical power signals are transmitted.

FIG. 2 shows a frequency diagram for different signals. The horizontal axis indicates the frequency, and the vertical axis indicates the intensity of the signals. The frequency diagram is illustrative, and not to scale. At the frequency zero, the direct-current signals DC are transmitted. The direct-current signals DC serve as a remote power feed. They are normally transmitted in the telecommunications network 1, for example, for remote feeding of power to analog telephones. The alternating-current signals AC are normally transmitted at the frequency 50 Hz. The alternating-current signals are transmitted in the low voltage range, at 110 volts in some countries and at 220 volts in other countries, and serve to supply electrical power to equipment of the end customer. They are transmitted as power signals via the power signal network 2 and forwarded into the in-house power supply network 5. Above 50 Hz, various frequency ranges are reserved for the transmission of telecommunications signals. These telecommunications signals are transmitted in the telecommunications network 1 and forwarded via the in-house power supply network 5. A first frequency range is reserved, for example, for the transmission of POTS signals; POTS=plain old telephone network. Analog telephone services are offered by means of the POTS signals. A second frequency range, above the first frequency range, is reserved, for example, for the transmission of ISDN; ISDN=integrated services digital network. Digital services, in particular, digital telephone services, are offered by means of the ISDN signals. A third frequency range, above the second frequency range, is reserved, for example, for the transmission of DSL signals; DSL=digital subscriber line. There are different variants of DSL, for example, ADSL, VDSL, HDSL, SDSL, etc. Digital services, in particular, digital data services such as, for example, Internet applications, e-mail and video telephony, are offered by means of the DSL signals.

FIG. 3 shows a detailed representation of the connection, according to the invention, to the in-house power supply network from FIG. 1. The facility 4 connects the external telecommunications network 1 and the external power supply network 2 to the in-house power supply network 5. The facility 4 contains a power meter 6, a facility 7 and a fuse box 8, which are connected in series.

The power meter 6 is a standard power meter, which is usually located in the cellar of a house and serves to record the power consumption of the end customer.

The fuse box 8 is a standard fuse box, which is usually located within the end customer's living area, in the hall, and serves both to protect the in-house power supply network from overload, by means of electrical fuses, and to effect distribution to different electrical lines. Within the end customer's living area, there are then several power circuits with several sockets which, in total, form the in-house power supply network 5.

The facility 7 serves to connect the external telecommunications network 1 to the in-house power supply network 5.

FIG. 4 shows a development of the facility 7 from FIG. 3.

The facility 7 comprises a filter 9 and a filter 10.

The filter 10 serves to forward telecommunications signals and to block direct-current signals. It is connected between the telecommunications network 1 and the in-house power supply network 5. The filter 10 is a high-pass filter with a limiting frequency in the range from 50 Hz to 70 Hz, or a bandpass filter with a lower limiting frequency in the range from 50 Hz to 70 Hz, or the like. The selection of the limiting frequency above 50 Hz firstly prevents direct-current signals DC from being forwarded. Direct-current signals DC from the telecommunications network 1 are thus not forwarded into either the power supply network 2 or the power supply network 5. Secondly, it prevents the forwarding of alternating-current signals AC. Alternating-current signals AC are thus not forwarded into the telecommunications network 1. The filter 10 thus blocks direct-current signals DC and alternating-current signals AC, but is transmissive of telecommunications signals such as POTS, ISDN and DSL. The filter 10 is a passive filter which is bidirectional in function, so that telecommunications signals pass into the in-house power supply network 5 from the telecommunications network 1 and vice versa.

The filter 9 serves to block telecommunications signals and to forward alternating-current signals. It is connected between the in-house power supply network 5 of the end customer and the power supply network 2. The filter 9 is a low-pass filter with a limiting frequency in the range from 50 Hz to 70 Hz, or a bandpass filter with an upper limiting frequency in the range from 50 Hz to 70 Hz, or the like. The selection of the limiting frequency above 50 Hz prevents the forwarding of telecommunications signals. Consequently, neither telecommunications signals from the telecommunications network 1 nor telecommunications signals from the in-house power supply network 5 are forwarded into the power supply network 2. The filter 9 thus blocks telecommunications signals, but is transmissive of alternating-current signals AC which are forwarded from the power supply network 2 into the in-house power supply network 5. If a bandpass filter is used, alternating-current signals are additionally blocked.

In order to increase reliability, it is possible to use a series connection of two filters instead of the filter 10. Each of these two filters has the same structure as the filter 10. Likewise, two filters can be used instead of one filter 9.

Overall, the facility 7 represents a cost-effective device of small dimensions which can be easily looped into the power circuit close to the power meter, for example, in the cellar, and connected to the telecommunications network 1, the connection of which is normally located immediately adjacent to the power meter, in the utility room.

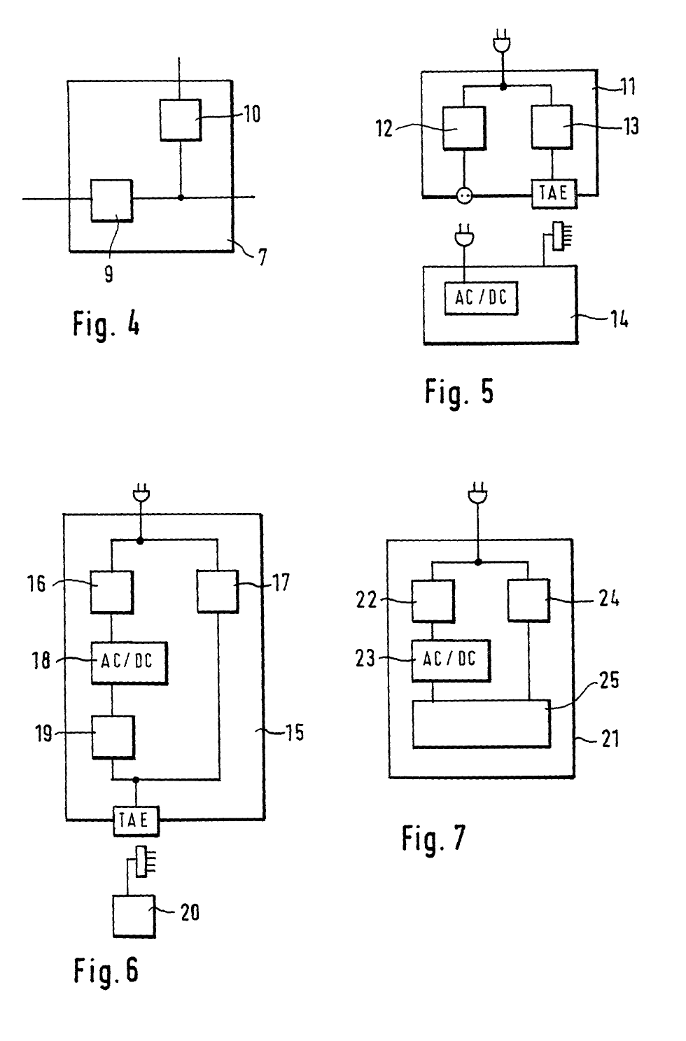

FIG. 5 shows an adapter and a terminal device. The adapter 11 has three connections. The first connection is a 110 and/or 220 volt plug which can be inserted in a socket of the in-house power supply network 5. Both power signals and telecommunications signals are received, and telecommunications signals are sent, via the first connection. The second connection is a TAE socket, in which a corresponding mating part, a TAE plug connector of the terminal device 14, can be inserted. Bidirectional telecommunications signals are transmitted via the second connection. The third connection is a socket connection in which a 110 and/or 220 volt plug can be inserted. The third connection serves to supply power to the terminal device 14.

The first connection is connected to the second connection via a filter 13. The filter 13 is a high-pass filter with a limiting frequency in the range from 50 Hz to 70 Hz, or a bandpass filter with a lower limiting frequency in the range from 50 Hz to 70 Hz, or the like. The selection of the limiting frequency above 50 Hz firstly prevents alternating-current signals AC from being forwarded. The filter 13 thus blocks alternating-current signals AC and forwards telecommunications signals. The first connection is additionally connected to the third connection, via a filter 12. The filter 12 is a low-pass filter with a limiting frequency in the range from 50 Hz to 70 Hz, or a bandpass filter with an upper limiting frequency in the range from 50 Hz to 70 Hz, or the like. The selection of the limiting frequency above 50 Hz prevents the forwarding of telecommunications signals. The filter 12 thus blocks telecommunications signals and forwards alternating-current signals AC.

The terminal device 14 comprises an ac/dc converter AC/DC which, from the received alternating-current signals AC, generates direct-current signals which serve as a power supply to the terminal device. The terminal device 14 is, for example, a DECT telephone with a charging station, a fax machine or a computer.

FIG. 6 shows a further adapter and a further terminal device.

The adapter 15 has two connections. The first connection is a 110 and/or 220 volt plug which can be inserted in a socket of the in-house power supply network. Both power signals and telecommunications signals are received, and telecommunications signals are sent, via the first connection. The second connection is a TAE socket, in which a corresponding mating part, a TAE plug connector of the terminal device 20, can be inserted. Bidirectional telecommunications signals are transmitted via the second connection, as well as a remote power feed for the terminal device 20, in the form of unidirectional direct-current signals DC.

The adapter 15 includes three filters and an ac/dc converter 18.

The filter 17 is a high-pass filter with a limiting frequency in the range from 50 Hz to 70 Hz, or a bandpass filter with a lower limiting frequency in the range from 50 Hz to 70 Hz, or the like. The selection of the limiting frequency above 50 Hz prevents the forwarding of alternating-current signals AC. The filter 17 thus blocks alternating-current signals AC and forwards telecommunications signals.

The filter 16 is a low-pass filter with a limiting frequency in the range from 50 Hz to 70 Hz, or a bandpass filter with an upper limiting frequency in the range from 50 Hz to 70 Hz, or the like. The selection of the limiting frequency above 50 Hz prevents the forwarding of telecommunications signals. The filter 12 thus blocks telecommunications signals and forwards alternating-current signals AC.

The filter 19 is a low-pass filter with a limiting frequency in the range from 50 Hz to 70 Hz, or a bandpass filter with an upper limiting frequency in the range from 50 Hz to 70 Hz, or a low-pass filter with a limiting frequency in the range around 10 Hz, or the like. The selection of the limiting frequency above 50 Hz prevents the forwarding of telecommunications signals. The filter 19 thus blocks telecommunications signals and forwards direct-current signals DC.

The terminal device 20 is, for example, an analog telephone.

FIG. 7 shows a further terminal device.

The terminal device 21 is a terminal device with an integral adapter. The unit 25 includes the usual function of the terminal device. An ac/dc converter 23 is provided for supplying power to the modules of the terminal device 21. Additionally provided are two filters 22 and 24, as well as a 110 and/or 220 volt connection for connecting to a socket of the in-house power supply network 5. The terminal 21 is, for example, a computer or a DECT telephone with a charging station. Telecommunications signals are transmitted via the filter 24, and alternating-current signals AC via the filter 22. The filter 22 is, for example, a low-pass filter with a limiting frequency in the range from 50 Hz to 70 Hz, or a bandpass filter with an upper limiting frequency in the range from 50 Hz to 70 Hz and a lower limiting frequency in the range from 30 to 50 Hz, or the like. The filter 24 is, for example, a high-pass filter with a limiting frequency in the range from 50 Hz to 70 Hz, or a bandpass filter with a lower limiting frequency in the range from 50 Hz to 70 Hz, or the like.

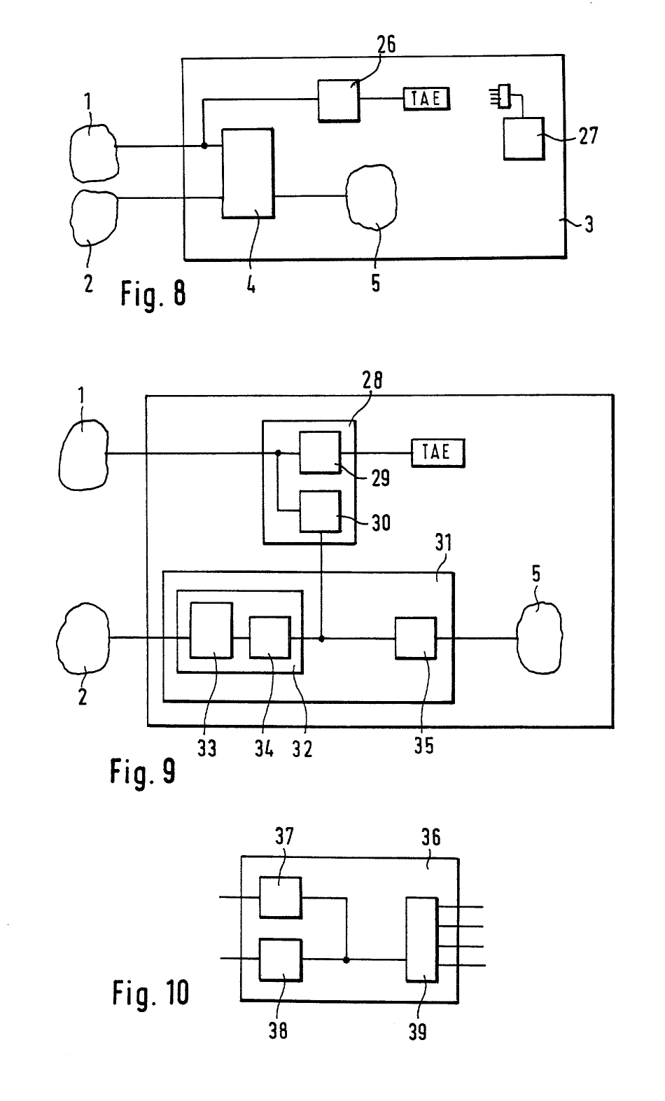

FIG. 8 shows a schematic representation of a further connection to the in-house power supply network. Provided in addition to the connection according to FIG. 1 is a network termination 26 which is connected to the telecommunications network. Connected to the network termination 26 is an in-house telecommunications network which, in the simplest case, can consist of a line with a TAE socket. A terminal device 27 can be connected to the TAE socket. For example, a standard analog telephone is connected to the TAE socket. In addition, it is possible to connect to a socket in the house a computer which has a fast Internet access, for example, via DSL, which is independent of the analog telephony, so that it is possible to simultaneously telephone and surf the Internet.

The second embodiment example is now explained with reference to FIG. 9. FIG. 9 shows a schematic representation of a further connection to the in-house power supply network. The filters of the facility 7 from FIG. 4 are now locally divided. A network termination 28 with an integral filter 30 is provided, as well as a power meter 32 with an integral filter 34. The unit 29 in this case performs the usual function of the network termination and the filter 30 blocks the direct-current signals DC and the alternating-current signals AC and allows the telecommunications signals to pass through. The unit 33 performs the usual function of the power meter and the filter 34 blocks the telecommunications signals and allows the power signals to pass through. The connection of the external telecommunications network 1 to the in-house power supply network 5 is thus effected in the unit 31 with the power meter 32 and the fuse box 35. The filter 30 can also be integrated in the power meter instead of in the network termination 28.

The third embodiment example is now explained with reference to FIG. 10. FIG. 10 shows a structure of a fuse box. The filters of the facility 7 from FIG. 4 are now locally integrated into the fuse box. The fuse box 36 thus replaces the fuse box 8 and the facility 7 from FIG. 3. The unit 39 in this case performs the usual functions of a fuse box. The filter 37 blocks the direct-current signals DC and the alternating-current signals AC and allows the telecommunications signals to pass through. The filter 38 blocks the telecommunications signals and allows the power signals to pass through.

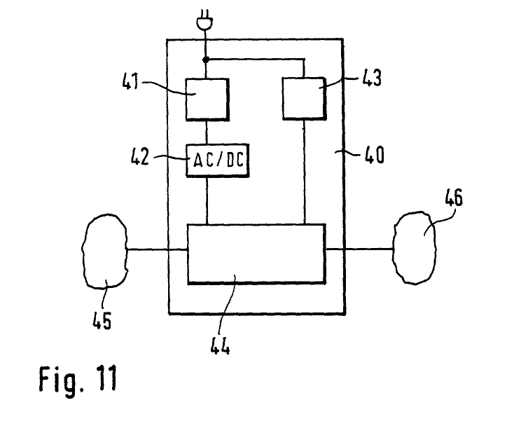

The fourth embodiment example is now explained with reference to FIG. 11. FIG. 11 shows a structure of a telecommunications exchange.

The telecommunications exchange 40 includes the unit 44, which performs the usual functions of a telecommunications exchange. Additionally provided are the filters 41 and 43, as well as the ac/dc converter 42. Three connections are provided. One connection serves to connect the telecommunications exchange 40 to an external telecommunications network 45, a further connection serves the purpose of connecting to an internal telecommunications network 46 and a further connection serves the purpose of connecting to an in-house power supply network via a 110 and/or 220 volt plug. In this way, the external telecommunications network 45 can be connected to the in-house power supply network. The 110 and/or 220 volt plug is inserted in, for example, a socket of the in-house power supply network or a socket in the fuse box. The filter 41 allows power signals to pass through and blocks telecommunications signals. Alternating-current signals AC thus reach the ac/dc converter 42, which provides the direct-current supply for the modules of the telecommunications exchange 40. The filter 43 allows telecommunications signals to pass through and blocks power signals. Telecommunications signals are passed into the in-house power supply network and telecommunications signals are received from the in-house power supply network via the filter 43.

Any combinations of the embodiment examples are possible. The lines of the in-house power supply network are, for example, a/b lines or so-called lead/tip lines, in addition to power supply lines. The telecommunications signals are transmitted by means of, for example, one or more of the following standards: ISDN, ATM, TCP/IP, E1-T1, ADSL. The terminal devices operate with, for example, ISDN, GSM, DECT, Bluetooth, UMTS. An adapter for ISDN terminal devices includes, for example, a 110 and/or 220 volt connection, a TAE socket connection, a 60 Hz low-pass and a subsequently connected ac/dc converter for generating the direct current, a 60 Hz high-pass and a subsequently connected 2-wire-4-wire converter, fed with the direct current, for generating a S₀ interface. The telecommunications signals are supplied to the TAE socket via a S₀ interface, together with the direct current. Control signals can also be transmitted via the in-house power supply network and the external telecommunications network, in addition to telecommunications signals. Control signals perform, for example, house control functions, e.g. for heating, refrigerator, television set, coffee machine and intelligent domestic appliances.

1. Facility for an end customer for generating a connection between a telecommunications network of a network operator and an in-house power supply network of the end customer for rendering possible the transmission of telecommunications signals (POTS; ISDN; DSL) via the in-house power supply network of the end customer.

2. Facility according to claim 1, wherein the facility comprises a filter for forwarding telecommunications signals (POTS; ISDN; DSL) and for blocking direct-current signals and the filter is connected between the telecommunications network and the in-house power supply network.

3. Facility according to claim 1, wherein the facility comprises a filter for blocking telecommunications signals (POTS; ISDN; DSL) and for forwarding alternating-current signals and the filter is connected between the in-house power supply network of the end customer and a power supply network of a power network operator.

4. Facility according to claim 2, wherein the filter is a high-pass filter with a limiting frequency in the range from 50 Hz to 70 Hz, or a bandpass filter with a lower limiting frequency in the range from 50 Hz to 70 Hz.

5. Facility according to claim 3, wherein the filter is a low-pass filter with a limiting frequency in the range from 50 Hz to 70 Hz, or a bandpass filter with an upper limiting frequency in the range from 50 Hz to 70 Hz.

6. Facility according to claim 1, wherein the facility is designed as a power meter or fuse box with an interface to the telecommunications network or as a network termination or telecommunications exchange with a telecommunications interface to the in-house power supply network of the end customer.

7. Local, in-house power supply network of an end customer, comprising a facility for generating a connection between a telecommunications network of a network operator and the in-house power supply network of the end customer, for rendering possible the transmission of telecommunications signals (POTS; ISDN; DSL) via the in-house power supply network of the end customer.

8. Method for the transmission of telecommunications signals, in which telecommunications signals (POTS; ISDN; DSL) received from a telecommunications network of a network operator are forwarded via a local, in-house power supply network of an end customer.

9. Method according to claim 8, wherein direct-current signals received from the telecommunications network of the network operator are not forwarded via the local, in-house power supply network of the end customer.

10. Method according to claim 8, wherein telecommunications signals (POTS; ISDN; DSL) received from the local, in-house power supply network of the end customer are fed into the telecommunications network of the network operator.
